(19) United States
(12) Patent Application Publication
(10) Pub. No.: US 2024/0200631 A1
(43) Pub. Date: Jun. 20, 2024

(54) DEVICE TO REDUCE SUBSEA BLOWOUT PREVENTER VIBRATIONS

(71) Applicant: Chevron U.S.A. Inc., San Ramon, CA (US)

(72) Inventors: Wangming Lu, Katy, TX (US); David Crenshaw Barrow, Katy, TX (US)

(21) Appl. No.: 18/066,764

(22) Filed: Dec. 15, 2022

(51) Int. Cl. F16F 7/104; F16F 7/10

(52) U.S. Cl. CPC F16F 7/104; F16F 7/1034; F16F 2222/08; F16F 2232/08

(57) ABSTRACT

The present embodiments disclose a device for dampening the lateral vibrations on a blowout preventer (BOP). The device is a cylinder with a support bar and a mass contained within. The mass can move along the support bar and press against springs, thus dampening the vibrations made against a BOP and wellhead.

### FIELD OF THE DISCLOSURE

The present disclosure relates to a device designed to reduce vibrations on a subsea blowout preventer and wellhead.

### BACKGROUND

In subsea wellhead systems, movement of the ocean can fatigue the pipes and connections between the wellhead and the vessel. The wellhead industry has tried to improve wellhead fatigue life and thus to ensure safe offshore operations in many ways. For example, one way is to improve wellhead design, e.g. make the wellhead stronger and more fatigue resistant. But this would incur significant costs due to materials, fabrication, and installation. Another way is to isolate the load source, which in some cases in the BOP vibration, by tethering the BOP system. Another way is to enhance the strength of the wellhead system as a whole by using a bracing system to transfer some wellhead load to connected equipment. But tethering a BOP systems is expensive in an offshore environment, costing over ten million dollars for one campaign. Also, the pretension in the connected cables can be lost, causing the system unable to fulfill its design purpose. The use of conventional bracing systems may require a design change for wellhead manufacturers who are often reluctant to do so due to their concerns on both involved cost and more on potential damage on wellhead systems, whose failure may lead to catastrophic consequences to both personnel and environment.

These and other deficiencies exist. Therefore, there is a need to provide a device that overcome these deficiencies.

### SUMMARY OF THE DISCLOSURE

Aspects of the disclosed embodiments include a device for dampening the lateral vibrations against a blowout preventer.

Further features of the disclosed systems and methods, and the advantages offered thereby, are explained in greater detail hereinafter with reference to specific example embodiments illustrated in the accompanying drawings.

In some aspects, the techniques described herein relate to a device for dampening the lateral vibrations on a blowout preventer attached to a wellhead, the device including: a cylinder body including two ends; a support bar, wherein the support bar is inside the cylinder and extends laterally to the two ends; and a mass, wherein the mass is configured to move across the support bar, wherein the mass is attached to a pair of springs such that each spring extends from the end of the cylinder body to the mass.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 illustrates a subsea system up according to an exemplary embodiment.

FIG. 2 illustrates a vibration dampening device according to an exemplary embodiment.

FIG. 3 illustrates a vibration damper on a blowout preventer.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

To reduce the fatigue inflicted on a wellhead, BOP, and lower marine riser package (LMRP), the present embodiments describe a vibration damper designed to be a part of a BOP or LMRP or otherwise attached to a BOP or LMRP after it has been manufactured. A vibration damper can comprise a mass that can move along a support bar inside a chamber containing compressible viscous fluid, an orifice, and a spring connecting the mass to the chamber from inside. Furthermore, the disclosed vibration damper is specifically configured to reduce lateral vibration of a subsea blowout preventer (BOP) system and thus to improve the fatigue life of a subsea wellhead system, whose fatigue integrity is critical to the entire subsea well. Most, if not all, existing applications for vibration dampers are limited to civil structures such as tall buildings, tall towers, and bridges. Other applications include, but not limited to, automobile and aerospace industries. In the embodiments that follow, one or more vibration dampers can be mounted to a subsea BOP framing structure to achieve maximum vibration reduction. The current invention is much less costly than the above-mentioned existing approaches It requires minimal, if not none, design change on existing subsea BOP systems during implementation.

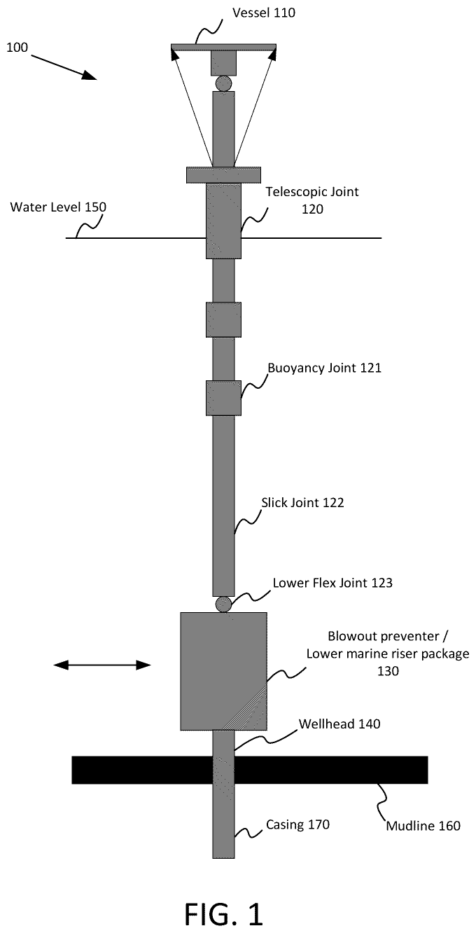

FIG. 1 illustrates a subsea wellhead system according to an exemplary embodiment. A vessel 110 can be connected to a subsea oil well through a series of connected joints and pipes comprising a drill string or well pipe or riser joint and subsea equipment such as BOP, LMRP, etc., and connectors in between. For example, the joint can include a telescopic joint 120, buoyancy joint 121, slick joint 122, and a lower flex joint 123. The blowout preventer (BOP) and lower marine riser package 130 can sit between the wellhead 140 and the lower flex joint 123, which is normally connected to a bottom riser joint or a pup joint through an adapter.

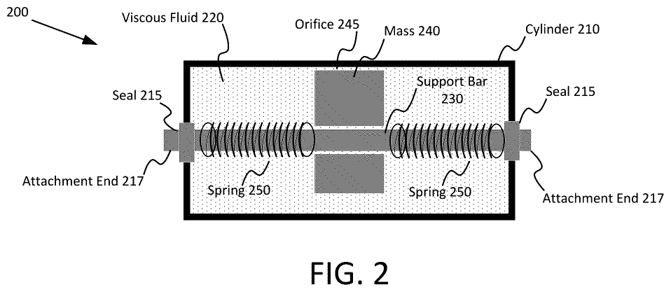

FIG. 2 is a diagram illustrating a vibration damper 200. The vibration damper 200 can comprise a cylinder 210 that is enclosed by two seals 215 at either end of the cylinder 210. The cylinder 210 can contain some amount of viscous fluid 220. Spanning the lateral ends of the cylinder 210 is a support bar 230. A mass 240 can move against two springs 250 attached at both ends of the cylinder 210. The mass 240 can move against either spring 250 as the vibration damper 200 is moving together with BOP.as lateral force is applied to the vibration damper 200. An orifice 245 comprising a gap between the mass 240 and the cylinder 210 can allow the mass 240 to move along the support bar 230 as well as allow viscous fluid 220 to move freely within the interior of the cylinder 210. On the outside of the cylinder can be one or more attachment ends 217 that can be used to attached two or more vibration dampers 200 together. In an exemplary embodiment, multiple vibration dampers can be placed on the outside of either or both the BOP or LMRP 130. The attachment ends 217 can be used to attach one or more dampers together or otherwise attached the dampers to the interior or exterior of one or more BOPs.

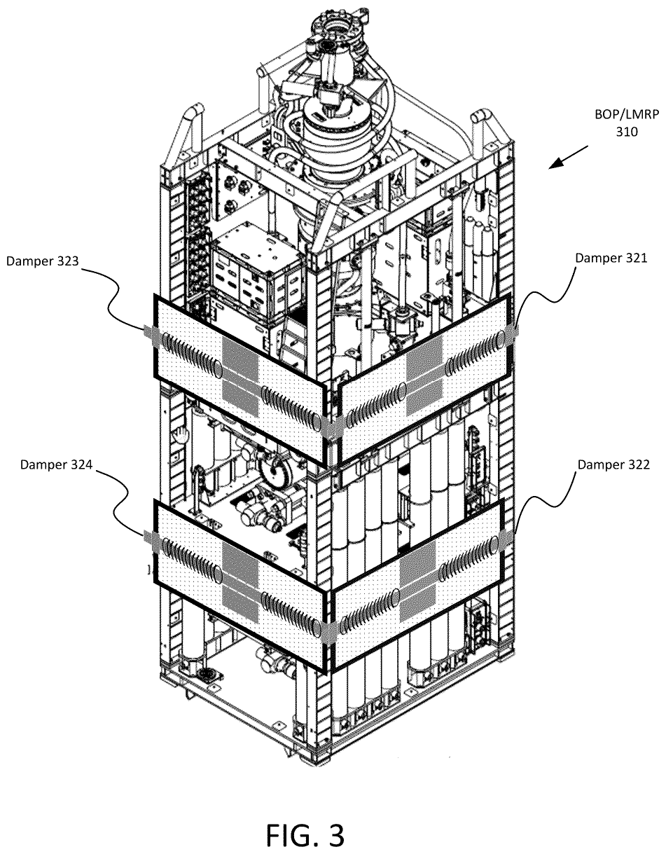

FIG. 3 is a diagram illustrating one or more dampers on a BOP or LMRP 310. A BOP 310 can be configured with one or more vibrational dampers 321, 322, 323, and 324 discussed with reference to FIG. 2. Each side of the BOP 310 can have one or more dampers to reduce fatigue on the BOP itself and the wellhead. The dampers can be arranged such that force or movement from any direction is mitigated or damped. Although FIG. 3 shows only four dampers, it is understood that in other embodiments more or fewer dampers can be used. In some embodiments, the dampers can be manufactured as a permanent element of the BOP. In other embodiments, the dampers can be manufactured such that they can be fixed or attached to the BOP after the BOP has already been manufactured. The dampers can be secured or affixed to either or both the exterior or interior of the BOP.

In some aspects, the techniques described herein relate to a device for dampening the lateral vibrations on a blowout preventer attached to a wellhead, the device including: a cylinder body including two ends; a support bar, wherein the support bar is inside the cylinder and extends laterally to the two ends; and a mass, wherein the mass is configured to move across the support bar, wherein the mass is attached to a pair of springs such that each spring extends from the end of the cylinder body to the mass.

In some aspects, the techniques described herein relate to a device, wherein the cylinder is a closed cylinder further containing viscous fluid.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

What is claimed is:

1. A device for dampening the vibrations on a blowout preventer attached to a wellhead, the device comprising:
a cylinder body comprising two ends;
a support bar, wherein the support bar is inside the cylinder and extends laterally to the two ends; and
a mass, wherein the mass is configured to move across the support bar, wherein the mass is attached to a pair of springs such that each spring extends from the end of the cylinder body to the mass.

2. The device of claim 1, wherein the cylinder is a closed cylinder further containing viscous fluid.
